(19) United States
(12) Patent Application Publication
(10) Pub. No.: US 2024/0388022 A1
(43) Pub. Date: Nov. 21, 2024

(54) ELECTRIC CONTACT ELEMENT

(71) Applicant: PHOENIX CONTACT GMBH & CO. KG, Blomberg (DE)

(72) Inventors: Karsten KROME, Detmold (DE); Ulrich ROSEMEYER, Schieder-Schwalenberg (DE)

(21) Appl. No.: 18/693,167

(22) PCT Filed: Sep. 14, 2022
(86) PCT No.: PCT/EP2022/075515

§ 371 Date: Mar. 19, 2024

(30) Foreign Application Priority Data
Sep. 21, 2021 (LU) LU500674

(51) Int. Cl. H01R 12/70; H01R 13/11; H01R 43/16

(52) U.S. Cl. CPC H01R 12/707; H01R 13/112; H01R 43/16

(57) ABSTRACT

An electric contact element for contacting a printed circuit board includes: a contact strip having a contact web and a contact lug disposed on a section of the contact strip, the contact lug extending at least partially together with the contact strip in a direction of extension of the contact strip and being angled in a region toward the printed circuit board as an angled region, the angled region having a first face for contacting the printed circuit board and a second face opposite the first face. The second face of the angled region is at least partially disposed on the contact web so as to be supported by the contact web.

### CROSS-REFERENCE TO PRIOR APPLICATIONS

This application is a U.S. National Phase application under 35 U.S.C. § 371 of International Application No. PCT/EP2022/075515, filed on Sep. 14, 2022, and claims benefit to Luxembourgian Patent Application No. LU500674, filed on Sep. 21, 2021. The International Application was published in German on Mar. 30, 2023 as WO/2023/046550 A1 under PCT Article 21 (2).

### FIELD

The invention relates to an electric contact element for contacting a printed circuit board. The invention further relates to a contact carrier having at least one electric contact element and to a method for manufacturing an electric contact element.

### BACKGROUND

Such an electric contact element includes a contact strip having a contact web and a contact lug which is disposed on a section of the contact strip, the contact lug extending at least partially together with the contact strip in a direction of extension of the contact strip and being angled in a region toward the printed circuit board, and the angled region having a first face for contacting the printed circuit board and a second face opposite the first face.

In the prior art, printed circuit boards, which may also be referred to as circuit boards, are often equipped with such electric contact elements using surface-mounted device (SMD) soldering technology. With SMD soldering technology, printed circuit boards are typically equipped with contact carriers, which may also be referred to as electrical components, having a plurality of such electric contact elements. To this end, the angled regions of the contact lugs are placed planarly into a solder pad coated with solder paste in order to then be passed through a soldering furnace together with the contact carrier. In order to ensure that all electric contact elements make contact with the solder paste, the differences in height of the contacts should be less than the solder paste thickness. Typical values for a so-called “coplanarity” are in a range from 150 μm to 100 μm. The contact lugs may be angled in order to enlarge the contact surface toward the printed circuit board.

Such electric contact elements are illustratively described in documents DE 10 2018 000 204 A1, DE 10 2012 105 995 B4, EP 2 639 894 B1, and EP 1 930 987 A3.

However, the electric contact elements known from the prior art have the disadvantage that such angles can frequently not be produced reproducibly with sufficient accuracy to meet the coplanarity requirements. Especially when using springy materials for the electric contact element, there is a risk that the contact strip is deformed only within the elastic range and that it therefore springs back during attachment of the electric contact element and consequently does not meet the coplanarity requirements. In the worst case, this can result in a cold solder joint and, thus, in the interruption of the electric contact.

### SUMMARY

In an embodiment, the present invention provides an electric contact element for contacting a printed circuit board, comprising: a contact strip having a contact web and a contact lug disposed on a section of the contact strip, the contact lug extending at least partially together with the contact strip in a direction of extension of the contact strip and being angled in a region toward the printed circuit board as an angled region, the angled region having a first face configured to contact the printed circuit board and a second face opposite the first face, wherein the second face of the angled region is at least partially disposed on the contact web so as to be supported by the contact web.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIGS. 1A and 1B are views of an electric contact element according to an embodiment:

FIGS. 2A and 2B are views of a provided contact strip having a contact web and a contact lug disposed on the contact strip:

FIGS. 3A and 3B are views of the contact strip with an angled region:

FIGS. 4A and 4B are views showing the contact lug disposed on the section of the contact strip as it is bent therearound to position the second face on the contact web; and

FIG. 5 shows steps of a method for manufacturing the electric contact element.

### DETAILED DESCRIPTION

In an embodiment, the present invention provides an electric contact element that makes it possible to produce accurate angles in a reproducible manner, regardless of the elasticity of the material used for the contact element, in order to meet the coplanarity requirements.

Accordingly, the second face of the angled region is at least partially disposed on the contact web so as to be supported by the contact web.

The electric contact element may be formed as a single piece, for example, as a stamped and bent part, or as a multi-piece member from an electrically conductive material and may establish an electrical connection from the electric contact element to a conductor path or to a terminal contact on the printed circuit board.

For this purpose, the contact element includes a contact strip having a contact web and a contact lug disposed on a section of the contact strip. The term “contact web” can be used to denote a strip-shaped section of the contact strip, which extends, for example, at least partially along a side of the contact strip, for example along a side of the contact strip that faces toward the printed circuit board in the assembled state. The contact lug may, for example, be disposed laterally on the contact strip or may be formed integrally with the contact strip. To this end, the contact strip and the contact lug may initially lie in one plane during the manufacture of the electric contact element. The contact lug may then be angled in a region toward the printed circuit board at an angle of preferably less than or equal to 90°. “Angled” can be understood herein to refer to a bending of the material of the contact lug. For example, the contact element with the angled contact lug may be substantially l-shaped in side view.

The first face of the angled region, which faces the printed circuit board in the assembled state, is used for electrically contacting the printed circuit board or for electrically contacting a contact surface or conductor path disposed on the printed circuit board.

The second face of the angled region, which is opposite the first face, is at least partially disposed on the contact web so as to be supported by the contact web. This can be accomplished, for example, by bending the contact lug relative to the contact strip, for example, by bending it around the section where the contact lug is disposed on the contact strip.

“Disposed on the contact web” can be understood to mean that the second face of the angled region is mechanically in contact with the contact web or rests on the contact web. Such disposition on the contact web advantageously makes it possible to produce accurate angles in a reproducible manner, regardless of the material used, in order to meet the coplanarity requirements.

In an example, the contact lug is disposed laterally on the section of the contact strip in a direction of extension of the contact strip. The contact strip may, for example, be substantially rectangular in shape and extend in the direction of extension with the long sides from a first end region to a second end region. The contact web may be formed by a short side of the rectangle at the second end region, which faces the printed circuit board in the assembled state. “Lateral disposition” can be understood to mean, for example, disposition on a long side, with the contact lug being disposed on the long side, for example, in the manner of a hook.

Advantageously, such disposition of the contact lug enables a particularly simple manufacture of the electric contact element, since the electric contact element can be stamped out in one piece, for example from sheet metal, and can be completed by means of subsequent bending operations.

In alternative examples, the contact lug may also be disposed differently on the contact strip. For example, the contact lug may be formed by a U-shaped cutout in the material of the contact lug, which is bent out of the plane of the contact lug.

In an example, the angled region extends at an angle of less than or equal to 90°, in particular less than 90°, between two surfaces of the contact lug.

In alternative examples, the angle may also be selected to be greater than or equal to 90°, in particular greater than 90°.

This makes it possible, for example, to obtain a contact lug that is substantially 1-shaped in side view.

In particular, when the angled region is disposed at such angles of less than 90° on the contact web, for example by bending the contact lug relative to the contact strip, the angled region can advantageously rest on the contact web with a preload corresponding to the angle.

In an example, the contact lug is adapted to be bent around the section of the contact strip to position the second face of the angled region on the contact web.

This advantageously allows the angled region to be slid onto the contact web of the contact strip so as to be supported by the contact web.

In an example, at least one chamfer is provided in an edge region of the contact web and/or of the angled region.

This advantageously makes it easier to slide the angled region onto the contact web of the contact strip.

In an example, the angled region is disposed perpendicular to the contact web.

This advantageously allows a plurality of electric contact elements to be disposed side by side on the printed circuit board and to be electrically contacted from a side opposite the printed circuit board.

In an example, the electric contact element has at least one connecting element, in particular a spring element, which is disposed at an end of the contact strip opposite the contact web and adapted for electrical connection to a conductor.

The connecting element may take the form of, for example, a spring element. In alternative examples, the connecting element may also take the form of a pin element, a socket element, a clamping element, a solder element, or a combination of different such elements.

For electrical contacting purposes, the conductor can advantageously be connected to the electric contact element via a pluggable connection provided by the connecting element.

In an example, the first face of the angled region is adapted to be soldered on the printed circuit board, in particular to a contact surface on the printed circuit board.

For example, a solder paste or an adhesive can be simply applied using a stencil and melted around or cured by heat.

Advantageously, any remaining differences in height or minor positioning errors during mounting are automatically corrected by the surface tension of the liquid solder.

In an example, the electric contact element is formed in one piece from a springy and electrically conductive material.

Advantageously, the electric contact element can be easily and quickly formed in one piece by the bending operations described herein. This eliminates the need to join or assemble a plurality of components.

Moreover, in an example, the electric contact element advantageously may be formed as a stamped and bent part for this purpose.

The invention also relates to a contact carrier having at least one electric contact element, in particular a plurality of electric contact elements, as described herein.

The contact carrier may be an electrical component, for example a surface-mounted device (SMD). For example, the electrical component may be a passive component, such as a diode, but may also take the form of a semiconductor, such as an integrated circuit.

The invention further relates to a method for manufacturing an electric contact element for contacting a printed circuit board. The method includes the steps of:
providing a contact strip having a contact web and a contact lug disposed on the contact strip, the contact lug being disposed on a section of the contact strip and extending at least partially together with the contact strip in a direction of extension of the contact strip;
angling a region of the contact strip, the angled region having a first face for contacting the printed circuit board and a second face opposite the first face; and
bending the contact lug around the section of the contact strip to position the second face on the contact web so as to be supported by the contact web.

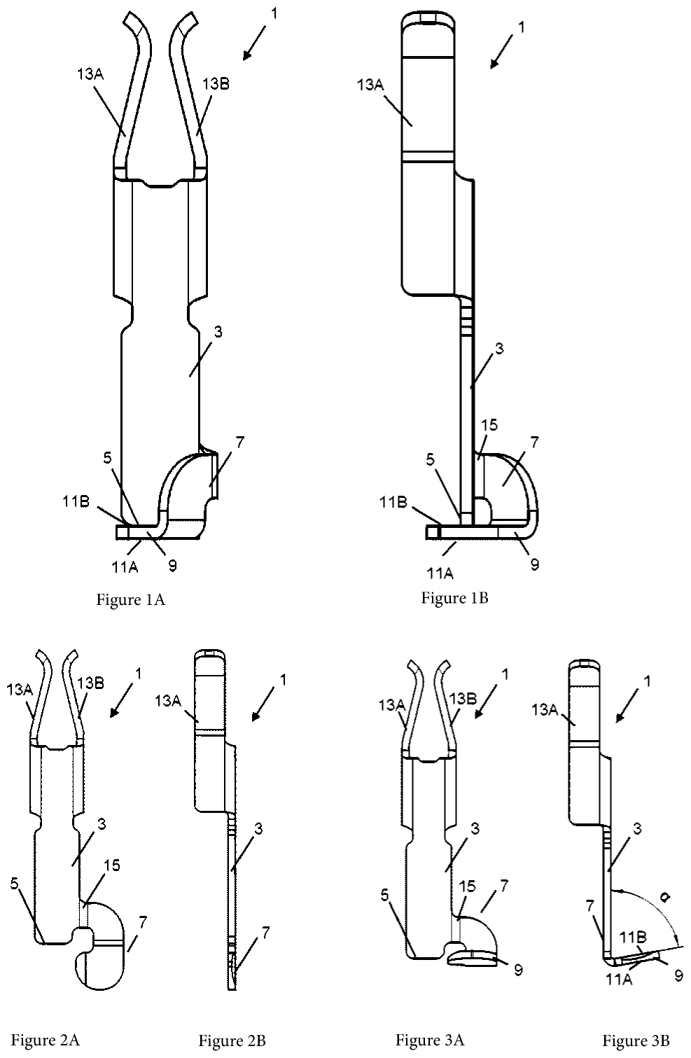

FIG. 1A shows a schematic front view and FIG. 1B a side view of an electric contact element 1 according to an embodiment.

The electric contact element 1 shown has a contact strip 3 having a contact web 5 and a contact lug 7 disposed on contact strip 3.

In the embodiment shown, contact strip 3 is substantially rectangular in shape and extends in the direction of extension with the long sides from a first end region to a second end region, the second end region facing the printed circuit board in the assembled state. As illustrated, contact web 5 is formed by a short side of the rectangle at the second end region. The contact lug 7 shown is disposed on a long side of contact strip 3.

FIGS. 1A and 1B further show that contact lug 7 is angled or bent in a region 9 toward the printed circuit board at an angle of preferably less than or equal to 90°.

First face 11A of angled region 9, which faces the printed circuit board, is used for contacting the printed circuit board or a contact surface or conductor path disposed on the printed circuit board.

Second face 11B of angled region 9, which is opposite the first face 11A, is at least partially disposed on contact web 5 so as to be supported by contact web 5. To this end, contact lug 7 is bent relative to contact strip 3 about section 15, where contact lug 7 is disposed on contact strip 3.

Furthermore, in the example shown, electric contact element 1 has two connecting elements 13A, 13B in the form of spring elements, which are disposed at an end of contact strip 3 opposite the contact web 5 and adapted for electrical connection to a conductor.

FIGS. 2 through 4 show the electric contact element 1 according to the various manufacturing steps of the method shown in FIG. 5.

Specifically, FIGS. 2A, 2B are views of a provided contact strip 3 having a contact web 5 and a contact lug 7 disposed on contact strip 3.

In the embodiment shown, the contact strip 3 shown may be formed as a stamped and bent part. The two connecting elements 13A, 13B formed as spring elements can be produced by bending the material of contact strip 7. The spring elements are shown in the figures only by way of example. As an alternative to the spring elements shown, other contacting means, such as pin elements, socket elements, clamping elements, solder elements, etc. may also be used.

As can be seen from FIGS. 2A and 2B, contact lug 7 is disposed laterally on contact strip 3 or formed integrally with contact strip 3. In the views illustrated in FIGS. 2A and 2B, contact strip 3 and contact lug 7 initially lie in a common first plane.

FIGS. 3A, 3B show views of contact strip 3 with an angled region 9.

As illustrated, contact lug 7 is angled in a region toward the printed circuit board at an angle α of preferably less than or equal to 90°. To this end, contact lug 7 was bent approximately in the middle into a second plane, which is disposed at the angle α to the first plane.

As illustrated, section 15, where contact lug 7 is disposed on contact strip 3, and region 9, which is angled toward the printed circuit board, are disposed at an angle of 90° relative to each other.

The side view shown in FIG. 3B illustrates the l-shaped configuration of the electric contact element 1 with the angled region 9 of contact lug 7.

First face 11A of angled region 9, which faces the printed circuit board, is used for contacting the printed circuit board or the contact surface or conductor path disposed on the printed circuit board.

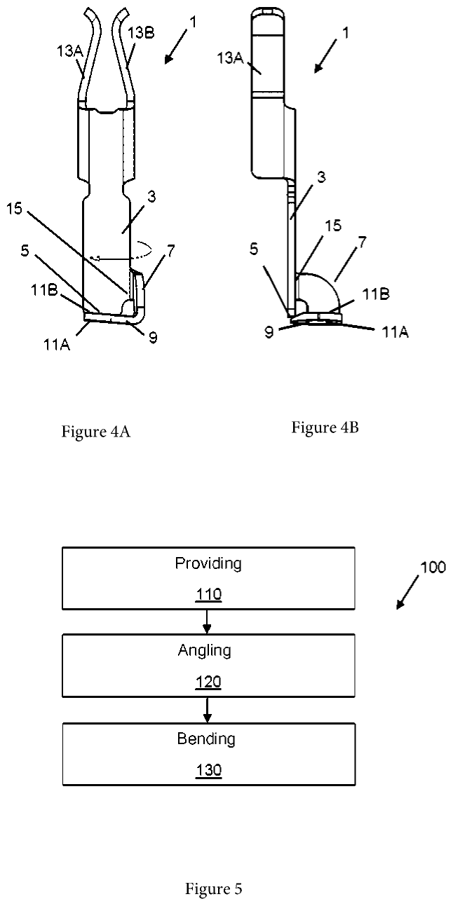

FIGS. 4A, 4B are views showing the contact lug 7 disposed on section 15 of contact strip 3 as it is bent therearound to position second face 11B on contact web 5. As illustrated, the bending around section 15 causes contact lug 7 to be bent into a third plane. The direction of bending is indicated by the arrow shown in FIG. 4A. Further bending in the direction of the arrow causes the second face 11 of the angled region to be slid further and further onto contact web 5 so as to be supported by contact web 5, as illustrated in FIGS. 1A and 1B.

FIG. 5 shows steps of a method 100 for manufacturing the previously described electric contact element 1.

The illustrated method 100 includes the steps of:

Providing 110 a contact strip having a contact web and a contact lug disposed on the contact strip, the contact lug being disposed on a section of the contact strip and extending at least partially together with the contact strip in a direction of extension of the contact strip.

Angling 120 a region of the contact strip, the angled region having a first face for contacting the printed circuit board and a second face opposite the first face.

Bending 130 the contact lug around the section of the contact strip to position the second face on the contact web so as to be supported by the contact web.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE CHARACTERS

1 electric contact element
3 contact strip
5 contact web
7 contact lug
9 angled region
11A, 11B first face, second face
13A, 13B connecting elements
15 section
α angle
100 method for manufacturing an electric contact element
110 providing
120 angling
130 bending

1. An electric contact element for contacting a printed circuit board, comprising:
a contact strip having a contact web and a contact lug disposed on a section of the contact strip, the contact lug extending at least partially together with the contact strip in a direction of extension of the contact strip and being angled in a region toward the printed circuit board as an angled region, the angled region having a first face configured to contact the printed circuit board and a second face opposite the first face,
wherein
the second face of the angled region is at least partially disposed on the contact web so as to be supported by the contact web.

2. The electric contact element of claim 1,
wherein the contact lug is disposed laterally on the section of the contact strip in a direction of direction of the contact strip.

3. The electric contact element of claim 1,
wherein the angled region extends at an angle less than or equal to 90° between two surfaces of the contact lug.

4. The electric contact element of claim 1,
wherein the contact lug is configured to be bent around the section of the contact strip to position the second face of the angled region on the contact web.

5. The electric contact element of claim 1,
wherein at least one chamfer is provided in an edge region of the contact web and/or of the angled region.

6. The electric contact element of claim 1,
wherein the angled region is disposed perpendicular to the contact web.

7. The electric contact element of claim 1,
further comprising:
at least one connecting element disposed at an end of the contact strip opposite the contact web and configured for electrical connection to a conductor.

8. The electric contact element of claim 1,
wherein the first face of the angled region is configured to be soldered on the printed circuit board.

9. The electric contact element of claim 1,
wherein the electric contact element is formed in one piece from a springy and electrically conductive material.

10. The electric contact element of claim 1,
wherein the electric contact element comprises a stamped and bent part.

11. A contact carrier, comprising:
at least one electric contact element of claim 1.

12. A method for manufacturing an electric contact element for contacting a printed circuit board, the method comprising:
providing a contact strip having a contact web and a contact lug disposed on the contact strip, the contact lug being disposed on a section of the contact strip and extending at least partially together with the contact strip in a direction of extension of the contact strip;
angling a region of the contact strip as an angled region, the angled region having a first face configured to contact the printed circuit board and a second face opposite the first face; and
bending the contact lug around the section of the contact strip to position the second face on the contact web so as to be supported by the contact web.

13. The electric contact element of claim 3, wherein the angled region extends at an less than 90° between two surfaces of the contact lug.

14. The electric contact element of claim 7, wherein the at least one connecting element comprises a spring element.

15. The electric contact element of claim 8, wherein the first face of the angled region is configured to be soldered to a contact surface on the printed circuit board.
